(19) United States
(12) Patent Application Publication
(10) Pub. No.: US 2026/0259054 A1
(43) Pub. Date: Sep. 3, 2026

(54) INERTIAL LOCALIZATION METHOD IMPLEMENTING A GRAVIMETRIC CORRELATION AND ASSOCIATED DEVICE

(71) Applicant: SAFRAN ELECTRONICS & DEFENSE, PARIS (FR)

(72) Inventor: Thierry PERROT, MOISSY CRAMAYEL (FR)

(21) Appl. No.: 18/873,023

(22) PCT Filed: Jun. 5, 2023
(86) PCT No.: PCT/FR2023/050789

§ 371 Date: Dec. 9, 2024

(30) Foreign Application Priority Data
Jun. 9, 2022 (FR) FR2205565

(51) Int. Cl. G01C 21/16

(52) U.S. Cl. CPC G01C 21/1652; G01C 21/1656

(57) ABSTRACT

A method for achieving inertial localization of a carrier using a stochastic filter of recursive-Bayesian type implemented by an inertial localization device, the method including a plurality of cycles, each cycle including a propagation procedure and, when a measurement is available, an updating procedure, in which method, in the propagation procedure, the propagation is performed using a propagation model taking into account at least one component of a matrix of the spatial gradients of the gravity vector, which matrix is delivering using an enriched gravimetric model.

### TECHNICAL FIELD OF THE INVENTION

The technical field of the invention is that of inertial localisation.

This invention relates to an inertial localisation method and in particular an inertial localisation method using gravimetric correlation by error propagation.

### TECHNOLOGICAL BACKGROUND OF THE INVENTION

Estimating a position of a mobile phone without GNSS assistance can be made using equipment comprising a gravimeter and an inertial localisation unit. A series of pairs (position, gravity) is searched for in a gravity map representative of the zone travelled based on the gravimeter measurements and the position estimated by the unit to correct position, where the gravity signal is a gravity function such as gravity, gravitation, gravity anomaly, gravity disturbance. Several methods exist for searching for pairs (position, gravimetric signal) in the map.

A first method is based on a simplified model of the position error. Over a given time interval, this error is modelled as an unknown constant. Estimating this constant is made by shifting the estimated trajectory in the search zone and searching for a correlation peak between the values read on the map along the trajectory shifted and the measurements taken over this time interval. This method is particularly useful when the position error is in the order of 10 km or more.

A second method using the gravimetric map is based on close hybridisation between the inertial localisation unit and the gravimeter. The navigation state is then optimally estimated at each observation based on all the previous inertial measurements and observations.

These two methods have one problem in common: the fact that the gravimeter is moving degrades accuracy of the measurement and therefore limits position correction. The higher the velocity, the less the position is corrected. This is partly due to the measurement time of the gravimeter and the variations in the field to which the gravimeter is subjected during the measurement. A measurement time of 10 seconds at a velocity of 900 km/h can lead to variations of 10 μg during the measurement in some geographical zones, whereas the intrinsic accuracy of an absolute gravimeter is typically in the order of 10 ng. The cost of equipment therefore becomes high relative to the quality of the measurement when the velocity increases.

GNSS and gravimeters are passive measurement means with the advantage of discretion, but GNSS is not always available and the gravimeter is less effective at high velocities. There is therefore a need for an inertial localisation method that can be used on carriers travelling at high velocity, without any restrictions on availability.

### SUMMARY OF THE INVENTION

The invention offers a solution to the problems discussed previously, by providing a method in which the external gravimeter can be replaced with a sensor whose measurement is a function of the position or velocity of the carrier, and in which an enriched gravimetric model is applied in the propagation model of the navigation state (position, velocity, attitude) at each position of the zone of uncertainty modelled by the unit, the term “enriched” meaning that this model makes it possible to describe the gravity field more finely than the normal model used by default in inertial localisation units, the normal gravity model being a term used in physical geodesy to designate the gravity field generated by a rotational equipotential reference ellipsoid modelling the surface of a planet and which, in the state of the art concerning the planet Earth, is that described by the WGS84 or GRS80 reference system.

For this, a first aspect of the invention relates to a method for inertially localising a carrier using a recursive Bayesian type stochastic filter implemented by an inertial localisation device, the method comprising a plurality of cycles, each cycle including a propagation step and an update step, in which method, in the propagation step, propagation is performed using a propagation model taking at least one component of a spatial gradient matrix of the gravity vector provided by an enriched gravity model into account.

Thus, during propagation, the navigation state (position, velocity, attitude) is calculated from the initial navigation state of each cycle, from the inertial measurements and from the enriched gravity model. The method according to the invention is particularly advantageous in that reading the enriched gravimetric model at the estimated position, which is different from the true position, creates a correlation between the velocity error and the position error in the vicinity of the estimated position, due to the non-uniform spatial distribution of the enriched gravimetric vector, and in that the stochastic filter calculates uncertainty by modelling this correlation during the propagation step by linearising the enriched gravimetric vector on the basis of the position at each propagation time instant in the form of a partially used spatial gradient matrix. Thus, a partial observation of the velocity makes it possible to correct part of the position via this correlation during the update step. Similarly, a partial observation of the position enables part of the velocity and another part of the position to be corrected in this same step.

By virtue of the invention, it is therefore possible to implement a method for localising carriers moving at high velocity by modelling propagation of the error over time intervals shorter than the cycle associated with the stochastic filter (for example the Kalman cycle when such a filter is used). In addition, this method can be implemented using a measurement that is not likely to be detected, for example a measurement of the carrier altitude or vertical velocity. Furthermore, its implementation requires very few calculation resources.

Further to the characteristics just discussed in the preceding paragraph, the method according to a first aspect of the invention may have one or more additional characteristics from among the following, considered individually or according to any technically possible combinations.

In one embodiment, the recursive Bayesian filter linearises the propagation law.

In one embodiment, the inertial localisation device comprises a calculation means, an inertial sensor block and at least one external sensor, and for each cycle k with k a positive non-zero integer:
during the propagation step, the navigation state at the end of the cycle X̅_{k,fin}, is calculated based on the navigation state at the start of the cycle X̅_{k,0}, of inertial measurements, and of the gravity vector obtained on the basis of the enriched gravimetric model, the error state δX_{k|k-1} is calculated based on the error state δX_{k-1|k-1}, and the covariance matrix P_{k|k-1} is calculated based on the covariance matrix P_{k-1|k-1}, calculating the error state and its covariance being performed using a transition matrix φₖ at cycle k and a model noise covariance matrix Qₖ at cycle k so that:

$$δ {X}_{k \vert k - 1} = {ϕ}_{k} δ {X}_{k - 1 \vert k - 1}$$

$${P}_{k \vert k - 1} = {ϕ}_{k} {P}_{k - 1 \vert k - 1} {ϕ}_{k}^{t} + {Q}_{k}$$

the transition matrix φₖ being determined using at least one component of the spatial gradient matrix of the gravity vector obtained based on the enriched gravimetric model,

an observation matrix Hₖ being then determined from the navigation state at the end of the cycle X̅_{k,fin} and an observation model;
during the update step, the error state after updating δX_{k|k} and the covariance matrix of the estimation error after updating P_{k|k} are calculated, by the calculation means and using the stochastic filter, from the error state before updating δX_{k|k-1}, the covariance matrix of the estimation error before updating P_{k|k-1}, the observation matrix Hₖ, a covariance matrix of the measurement noise Rₖ, and of an observation relating to at least one function of the velocity and/or position of the carrier made by the external sensor during or at the end of the propagation step so as to at least partly reduce the error state after updating.

In one embodiment, each filter cycle k is divided into N time intervals ΔT₁ as well as P time intervals ΔT₂ so that T_{filter}=NΔT₁=rPΔT₁=PΔT₂ with ΔT₂=rΔT₁ where N=rP and r and P are non-zero positive integers, where T_{filter} is the filter period, the propagation step of each filtering cycle comprising, from a propagation matrix F(t):
For each interval ΔT₁ marked with the index i with i between 1 and N, a sub-step of calculating the navigation state X̅_{k,j} by propagating the state X̅_{k,i-1} from the measurements of the inertial sensor block, the enriched gravimetric model at the position of the state X̅_{k,i-1};
For each interval ΔT₁ marked with index i between (j−1)r+1 and (j−1)r+r, j being an integer between 1 and P designating the index of an interval ΔT₂ with

$$j = E ( \frac{i - 1}{r} ) + 1$$

where E(x) is the floor of x, a sub-step of calculating an elementary transition matrix φ_{k,j} initialised at the identity matrix at the start of the time interval ΔT₁ marked with the index i=(j−1)r+1 and completed by integrating the propagation matrix F(t) relative to time over the r time intervals ΔT₁ making up the interval ΔT₂, the matrix obtained by integrating the propagation matrix over a time interval ΔT₁ being added to the matrix obtained upon integrating over the previous time interval ΔT₁ so as to progressively make up this elementary transition matrix φ_{k,j} and a transition matrix φₖ on cycle k initialised with the identity matrix being progressively calculated at each new value of j by the matrix product φₖ←φ_{k,j}, φₖ;
At the end of the last interval ΔT₁ of cycle k and therefore of the last interval ΔT₂ (i=N and j=P), a sub-step of determining the observation matrix Hₖ from the propagated navigation state X̅_{k,N} and an observation model, and a sub-step of propagating the error state and the covariance matrix of this state:

$$δ {X}_{k \vert k - 1} = {ϕ}_{k} δ {X}_{k - 1 \vert k - 1}$$

$${P}_{k \vert k - 1} = {ϕ}_{k} {P}_{k - 1 \vert k - 1} {ϕ}_{k}^{t} + {Q}_{k}$$

with the transition matrix φₖ obtained at the end of the last interval ΔT₂ at the cycle k considered.

In one embodiment, the inertial localisation device comprises a laser rangefinder and/or a lidar, and a measurement of the position and/or velocity of the carrier is performed by telemetry during the update step.

In one embodiment, the localisation device comprises a camera, and a measurement of the position and/or velocity of the carrier is performed by camera during the update step.

In one embodiment, the localisation device comprises a means for measuring the vertical position, and a measurement of the position and/or the vertical velocity of the carrier is performed by said measurement means during the update step.

In one embodiment, the inertial localisation device is a strapdown device mechanised in the local geographical reference frame (North, West, Top) or (North, East, Bottom).

In one embodiment, the inertial localisation device is a strapdown device mechanised in a reference frame, one of whose axes coincides with the vertical axis of the local geographical reference frame, known as the free azimuth reference frame. This reference frame makes it possible, in particular, to pass the geographical poles without causing a division by zero in calculations.

In one embodiment, the inertial localisation is a strapdown device mechanised in the planet-fixed geocentric reference frame (generally noted [t]).

In one embodiment, the inertial localisation is a strapdown device mechanised in the inertial geocentric reference frame (generally noted [i]).

In one embodiment, the inertial localisation device is a gimbal device.

A second aspect of the invention relates to an inertial localisation device comprising an inertial sensor block, at least one external sensor, a memory for storing the enriched gravimetric model, and means configured to implement a method according to one aspect of the invention.

A third aspect of the invention relates to a computer program comprising instructions which cause the device according to a second aspect of the invention, when these instructions are executed by the device, to implement the method according to a first aspect of the invention.

A fourth aspect of the invention relates to a computer-readable medium having the computer program according to a third aspect of the invention recorded thereon.

The invention and its different applications will be better understood upon reading the following description and upon examining the accompanying figures.

### BRIEF DESCRIPTION OF THE FIGURES

The figures are set forth byway of indicating and in no way limiting purposes of the invention.

FIG. 1 shows a schematic representation of the gravimetric correlation principle according to the invention.

FIG. 2 shows a schematic representation of the use of a Kalman filter to implement gravimetric correlation.

FIG. 3A shows a flowchart of a localisation method according to the invention.

FIG. 3B illustrates the operation of the algorithm for calculating the solution (position, velocity, attitude) on the basis of inertial measurements.

FIG. 4 shows a schematic representation of a localisation device according to the invention.

FIG. 5 compares the behaviour of error on horizontal position and heading, for inertial sensors isolated from the vibratory and thermal environment, between the state of the art and the method according to the invention.

FIG. 6A illustrates the time chart of calculations during the propagation step.

FIG. 6B illustrates the difference between closed loop states and open loop states.

FIG. 7 illustrates the definition of the planet-fixed geocentric reference frame [t] and the local geographic reference frame (North, West, Top) [g] as well as the definition of latitude L, longitude G and ellipsoidal altitude Z, also referred to as z_{g}.

FIG. 8 illustrates the definition of the planet-fixed geocentric reference frame [t] and the inertial geocentric reference frame [i].

### DETAILED DESCRIPTION

Unless otherwise specified, a same element appearing in different figures has a single reference.

### Introduction

Inertial localisation methods are generally implemented by an inertial localisation unit which gathers an inertial sensor block (comprising accelerometers and gyroscopes or gyrometers), a calculation means and, preferably, mechanical damping elements to which the inertial sensor block is usually mounted in order to minimise impact of shocks and vibrations on localisation accuracy. This inertial localisation unit can operate in a first mode, called the alignment mode, which corresponds to the initialisation of the navigation state using measurements from the inertial sensor block and/or an external sensor. The present invention does not relate to this first mode.

When the alignment is complete, the localisation unit can switch to navigation mode: it is this navigation mode that is the subject of the invention. In this mode, estimations of the navigation state are calculated in cycles using a stochastic filter (also referred to as a navigation filter), each cycle including at least two steps: a step of propagating the navigation state and the state of the stochastic filter; and a step of updating the navigation state and the state of the stochastic filter. The stochastic filter most commonly used in navigation is the extended Kalman filter. The propagation calculation is split between a non-linear propagation algorithm referred to as the “navigator” and an error propagation algorithm with linearised laws based on the navigator estimations at different time instants. The latter algorithm assumes that the errors are Gaussian and calculates the mathematical expectation and covariance matrix of the errors propagated. The observations are taken into account by the extended Kalman filter in an update step. This is the standard operation of an inertial localisation unit.

The method according to the invention differs from the standard operation described above in that the propagation model used during the propagation step to propagate the error state noted δX in the following takes at least one component, preferably a plurality of components into account, of the spatial gradient matrix of the gravimetric vector of an enriched gravimetric model, this component or these components being read into the model at the position of the carrier estimated by the navigator.

In one embodiment, by enriched gravimetric model, it is meant a model whose resolution is better than 15 arc minutes and whose RMS error is less than 15 mGal for most of the geographical zones (80% surface or more) likely to be travelled by the carrier. Resolution is generally defined as the mean gate spacing of the measurements brought back to the reference ellipsoid that allowed construction of the enriched model. For an overall model broken down into spherical harmonics, this corresponds to a model whose largest spherical harmonic degree is greater than approximately 700. In one preferred embodiment, the accelerometric errors provided by the inertial sensor block are less than about 10 mGal.

### Stochastic Filters

Although the invention is illustrated using an extended Kalman filter in the following, it is not restricted to this stochastic filter alone.

All variants of the extended Kalman filter in which the propagation step is performed with a linearised propagation law can be utilised: for example filters improving the convergence velocity, or filters improving numerical problems, or filters improving robustness problems.

Of course, there are still other variants of stochastic filters, but the principle of the invention (i.e. gravimetric correlation by propagation) is still valid, although it may take different forms.

### Enriched Gravity Models

As previously mentioned, in the method according to the invention, the gravimetric model is an enriched gravimetric model for defining the spatial gradient of the gravity vector at the estimated position of the carrier.

In contrast, in inertial localisation units of the state of the art, the gravity model used is the normal model or an approximation of said model, the same including 4 geodetic parameters which, in the case of the planet Earth, are defined in reference systems such as WGS84 or GRS80. The normal model describes the gravity field generated by a rotational, smooth, equipotential, ellipsoidal surface, endowed with the planet mass. The effect of topography on the gravity field is not modelled. The discrepancy between the true gravity field and the normal gravity field at a same position is referred to as the gravity disturbing field. It gives rise to vertical deviations and errors in the gravity modulus. Vertical deviations excite navigation errors and yield Schuler oscillations in horizontal position and velocity that can potentially diverge but can be partially damped by observations.

Admittedly, in the state of the art, vertical deviation models are employed to reduce these oscillations in different navigation systems. These models are by definition richer than the normal model. On the other hand, spatial gradients from the normal model are modelled in the error propagation model of the extended Kalman filter. However, in the state of the art, the spatial gradients of the enriched gravity vector are not modelled in the propagation matrix. As a result, in navigation systems using an enriched gravity model, an unmodelled correlation between the velocity error and the position error appears due to the fact that, in the navigator, the enriched gravity model is read at the estimated position and not at the true position. Further to this inconsistency, it appears that the velocity error contains information about the position error, and that some existing sensors may be able to sense this information in order to estimate the position error. The achievable performance depends on the richness of the gravimetric model and the quality of the accelerometers.

Global models, including EGM2008, EIGEN-6C4 and XGM2019, constructed from terrestrial and spatial gravity field measurements, enable the gravity field to be modelled with a resolution in the order of 10 km. Other state-of-the-art global models based on topography models reduce this resolution to 6 km. Better resolutions are achieved by some local models. These models include partially modelled errors.

### Schematic Illustration of the Principle of the Invention

Before illustrating the invention in detail, it may be useful to set forth in simplified form, in one embodiment in which the filter used is an extended Kalman filter, the principle on which it is based (i.e. gravimetric correlation by error propagation) in order to understand how, on the basis of at least one component of the spatial gradient of the enriched gravity vector, it is possible to improve evaluation of position and/or velocity and/or attitude by reducing the error on the same. This presentation will also show how the method according to the invention can be implemented even in the absence of a gravimeter, a position or velocity sensor being sufficient. In the simplified example described below, it is assumed that the gravity model is perfect or that the accelerometer measurements are perfect. Of course, this is not the case in reality and the operations set forth in the following paragraphs have to be performed taking errors in the model and/or the measurements into account.

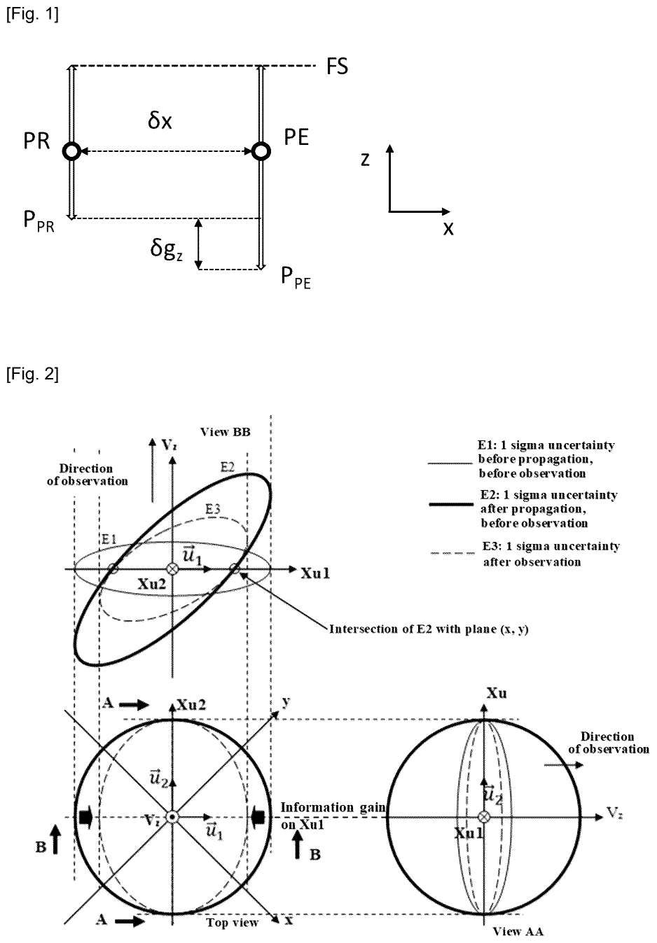

In [FIG. 1], two positions of a carrier, the actual position PR of the carrier, i.e. the position where the carrier is actually located, and the estimated position PE of this carrier, i.e. the position of the carrier estimated by an inertial localisation unit present in the carrier are represented.

Accelerometers of the inertial localisation unit measure a specific force FS at the actual position PR. To obtain the carrier acceleration, the navigator supplements this measurement with the gravity or gravitational vector (the gravity vector is the sum of the gravitational vector corresponding to universal attraction and centrifugal acceleration due to the rotation of the planet on which the carrier is located), as well as accelerations depending on the type of mechanisation used by the navigator and known from the state of the art (the mechanisation defines the reference frame in which the navigation is expressed). This gravity vector is derived from an enriched gravity model and is calculated at the estimated position PE. This acceleration is then used to calculate the carrier velocity at the next time instant and therefore also its position. Also, although the specific force FS results from a measurement, the value of the carrier acceleration is a function of an estimated value of the gravity vector calculated using an enriched model from the estimated position PE. An error in the estimated position PE is therefore propagated, by taking gravity into account, into an error in the acceleration of the carrier (and therefore in the velocity and position of the carrier, these quantities being obtained by integration).

In [FIG. 1], the position error on axis x axis is noted as δx. This error in position on the axis x causes a difference between the gravity along the axis z at the actual position PR and the gravity determined using a model at the estimated position PE, noted δg_{z} in [FIG. 1].

These two errors can be related to each other using the following relationship:

$$δ {g}_{z} = \frac{\partial {g}_{z}}{\partial x} δ x \qquad [ Math . 1 ]$$

Where δg_{z} is the error in the z component of gravity,

$$\frac{\partial {g}_{z}}{\partial x}$$

is the spatial gradient along axis x of the z component of gravity at the estimated position PE and δx is the error in the x component of the position.

As already mentioned, this error in the value of gravity along the axis z translates directly into an error in acceleration along that same axis, according to the relationship:

$$δ {a}_{z} = δ {g}_{z} = \frac{\partial {g}_{z}}{\partial x} δ x \qquad [ Math . 2 ]$$

It is possible to derive similar relationships for the error in the z component of the velocity so that, for a time interval T during which the gradient can be considered constant, the contribution of the position error to the velocity error z, apart from all other contributors, is:

$$δ {v}_{z} = T \frac{\partial {g}_{z}}{\partial x} δ x \qquad [ Math . 3 ]$$

In other words, it is possible to propagate the error δx on the error δv_{z} by establishing a (gravimetric) correlation between these two quantities. Furthermore, this propagation does not require an external measurement of the gravity vector or its spatial gradient (in general, states in the stochastic filter are reserved for estimating a correction to the gravity model, and this estimation can be considered as an internal measurement of the gravity vector), as the value of the vector and the spatial gradient can, for example, be provided by an enriched gravimetric model. An observation on the vertical path thereby enables the horizontal position to be corrected.

The preceding relationship is obviously an approximation serving to illustrate the invention and other additional terms are present so that the proportionality relationship [Math. 3] is not verified. However, this approximation makes it possible to set forth the principle of the invention in a simplified way.

### Inertial Localisation Method

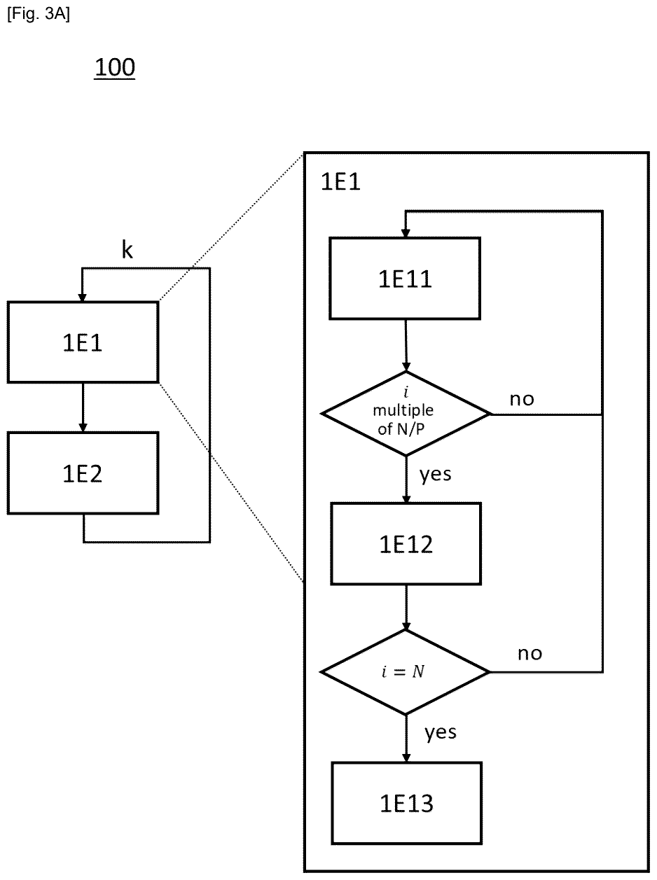

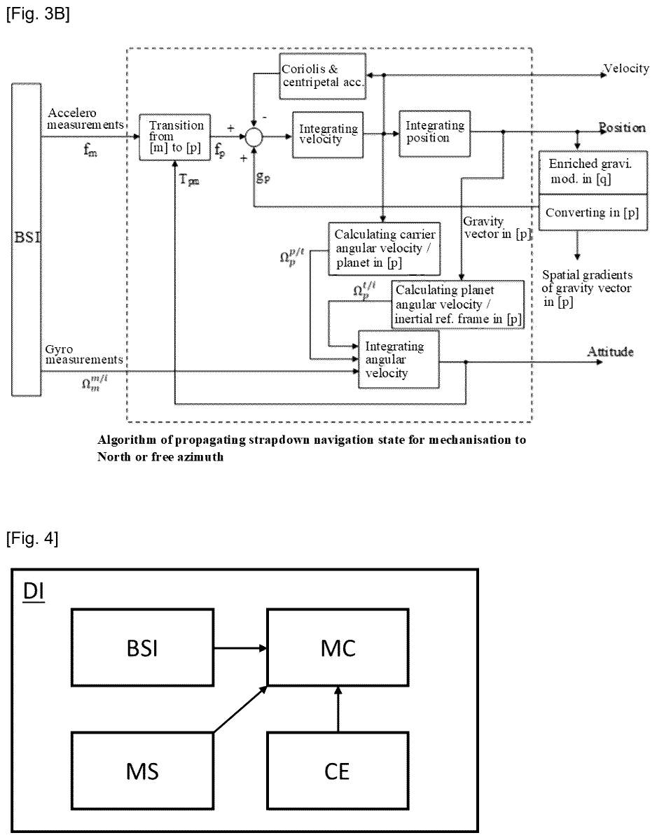

As illustrated in [FIG. 2], [FIG. 3A], [FIG. 3B] and [FIG. 4], a first aspect of the invention relates to a method 100 for inertially localising a carrier using a stochastic filter implemented by an inertial localisation device DI. The method 100 according to the invention comprises a plurality of cycles, each cycle comprising a propagation step 1E1 and an update step 1E2. Furthermore, in the method 100 according to the invention, during propagation step 1E1, propagation is performed using a propagation model taking at least one component of the spatial gradient matrix of the gravity vector provided using an enriched gravimetric model into account.

In one embodiment, the stochastic filter is an extended Kalman filter. Of course, as detailed in the introduction, other filters can be used within the scope of the invention, but the extended Kalman filter has been selected to illustrate the invention because it is the most common filter in the field of localisation.

In one embodiment illustrated in [FIG. 4], the inertial localisation device DI comprises a calculation means MC (for example a processor or an ASIC card), an inertial sensor block BSI, at least one external sensor CE, and a storage memory MS configured to store instructions and data necessary for implementing a method 100 according to the invention, and especially the enriched gravimetric model. In one preferred embodiment, a specific storage means is used to store the enriched gravimetric model, for example a second storage memory distinct from that storing instructions for implementing the method 100 according to the invention.

[FIG. 2] will be used to illustrate the different steps 1E1, 1E2 of the method 100 according to the invention. In this [FIG. 2], the invention is illustrated on two axes (axis x and axis y), and a measurement (or observation) of the velocity along the axis z. Thus, in this simplified illustration, the error state which, in reality, contains not only navigation errors but also errors in complementary states which help to reduce navigation errors, is reduced to the error on the state vector noted δX at time instant n and described by:

$$δ X = ( \begin{matrix}δ x \\ δ y \\ δ {v}_{z}\end{matrix} ) \qquad [ Math . 4 ]$$

Where δx is the uncertainty on the x component, δy is the uncertainty on the y component and δv_{z} is the uncertainty on the z component of the velocity.

Furthermore, still in order to illustrate the principle of the invention in the case of Gaussian error modelling, in [FIG. 2], the 1σ uncertainty ellipsoids are represented in projection in three planes:
The plane (x, y) bottom left;
The plane (Xu,₁ v_{z}) top left where Xu₁ represents the axis of the spatial gradient of the gravity vector of direction

$$\vec{{u}_{1}} = ( \begin{matrix}1 \\ 1 \\ 0\end{matrix} ) ;$$

The plane (v_{z}, Xu₂) bottom right, where Xu₂ represents the axis orthogonal to the gradient.

As discussed in the introduction, the method 100 according to the invention comprises two steps: a propagation step 1E1 and an update step 1E2, these two steps being repeated at a period T_{filter}, each repetition corresponding to a cycle k with k a non-zero natural number. The period T_{filter} is the period associated with the stochastic filter, in this case the extended Kalman filter. These two steps will be described in detail below.

In one embodiment, the enriched gravimetric model comprises a set of data and functions (for example interpolations or spherical or ellipsoidal harmonic functions) providing a gravimetric vector and a function of the spatial gradient matrix of this vector providing at least one spatial gradient for making approximations such as local mean gradient values, on the basis of the position of the carrier. For example, in the case of a gate, the spatial variation rate between two gate points is also an approximation of the gradient in that direction:

$$\frac{Δ {g}_{z}}{Δ x} = \frac{1}{Δ x} {\int }_{{x}_{1}}^{{x}_{1}} \frac{\partial {g}_{z}}{\partial x} d x = 〈 \frac{\partial {g}_{z}}{\partial x} 〉 .$$

This variation rate is therefore the mean value of the spatial gradient of g_{z} in the direction x.

In one alternative embodiment, the enriched gravity model provides a gravity vector and a spatial gradient matrix of this vector corresponding to the gravity vector g_{g} and a function of its Jacobian χ (J_{g}_{_{g}}) in a reference frame [g] (or geographical reference frame) at positions expressed in geographical coordinates (L, G, z_{g}) relative to the reference ellipsoid where L is the geographical latitude, G the longitude and z_{g} the ellipsoidal altitude, where χ( ) is a Jacobian approximating function, making it possible, for example, to force some terms to zero or to yield a local mean according to parameters, as well as an associated error model, the gravimetric vector and its spatial gradient matrix being γ_{q}=g_{g} and J_{γ}_{_{q}}=χ(J_{g}_{_{g}}) where [q] represents the mechanisation reference frame corresponding to the reference frame to which inertial localisation is slaved. For example, reference frame [g] makes the platform reference frame of the horizontal inertial localisation face North. If the inertial localisation is gimballed, the inertial sensor block is fixed relative to a horizontal mechanical platform facing North. If localisation is of the strapdown type, the inertial sensor block is fixed relative to the carrier and a virtual platform is calculated, being equivalent to the mechanical platform of the gimballed unit. In the state of the art, all units are of the strapdown type. In some cases, the strapdown unit can itself be mounted to a gimbal platform, making the virtual platform fixed relative to the physical platform. As a reminder, the free azimuth platform reference known to those skilled in the art makes it possible to pass the geographical poles and corresponds to a reference deduced from [g] by an angle α about the axis z_{g} where a is maintained by the West velocity of the carrier, or for example the geocentric terrestrial reference frame [t].

In addition:

$${g}_{g} = ( \begin{matrix}{g}_{{x}_{g}} \\ {g}_{{y}_{g}} \\ {g}_{{z}_{g}}\end{matrix} ) {J}_{{g}_{g}} = ( \begin{matrix}\frac{\partial {g}_{{x}_{g}}}{\partial {x}_{g}} & \frac{\partial {g}_{{x}_{g}}}{\partial {y}_{g}} & \frac{\partial {g}_{{x}_{g}}}{\partial {z}_{g}} \\ \frac{\partial {g}_{{y}_{t}}}{\partial {x}_{g}} & \frac{\partial {g}_{{y}_{g}}}{\partial {y}_{g}} & \frac{\partial {g}_{{y}_{g}}}{\partial {z}_{g}} \\ \frac{\partial {g}_{{z}_{t}}}{\partial {x}_{g}} & \frac{\partial {g}_{{z}_{t}}}{\partial {y}_{g}} & \frac{\partial {g}_{{z}_{g}}}{\partial {z}_{g}}\end{matrix} ) \qquad [ Math . 5 ]$$

Where (gₓ_{_{g}}, g_{y}_{_{g}}, g_{z}_{_{g}}) are the coordinates of the gravity vector in reference frame [g] at the position defined by latitude L, longitude G and ellipsoidal altitude z_{g} and where a component such as

$$\frac{\partial {g}_{{x}_{g}}}{\partial {y}_{g}}$$

represents the variation dgₓ_{_{g}} of gₓ_{_{g}} when the linear position (in metres as opposed to the angular position such as L and G) varies along the axis y of [g] by the value dy_{g}, the enriched gravity vector and its spatial gradient matrix being calculated by:

$${g}_{q} = {γ}_{q} {J}_{{g}_{q}} = {J}_{{γ}_{q}} \qquad [ Math . 6 ]$$

In one alternative embodiment, the enriched gravity model provides a gravity vector and a spatial gradient matrix of this vector corresponding to the gravity perturbation vector δg₉ and a function of its Jacobian χ (J_{δg}_{_{g}}) in the reference frame [g] at positions expressed in geographical coordinates (L, G, z_{g}) relative to the reference ellipsoid where L is the geographical latitude, G the longitude and z_{g} the ellipsoidal altitude, where χ( ) is a Jacobian approximating function, making it possible, for example, to force some terms to zero or to yield a local mean according to parameters, as well as an associated error model, the gravimetric vector and its spatial gradient matrix being γ_{q}=δg_{g} and J_{γ}_{_{q}}=χ(J_{δg}_{_{g}}) with:

$$δ {g}_{g} = ( \begin{matrix}δ {g}_{{x}_{g}} \\ δ {g}_{{y}_{g}} \\ δ {g}_{{z}_{g}}\end{matrix} ) {J}_{δ {g}_{g}} = ( \begin{matrix}\frac{\partial δ {g}_{{x}_{g}}}{\partial {x}_{g}} & \frac{\partial δ {g}_{{x}_{g}}}{\partial {y}_{g}} & \frac{\partial δ {g}_{{x}_{g}}}{\partial {z}_{g}} \\ \frac{\partial δ {g}_{{y}_{t}}}{\partial {x}_{g}} & \frac{\partial δ {g}_{{y}_{g}}}{\partial {y}_{g}} & \frac{\partial δ {g}_{{y}_{g}}}{\partial {z}_{g}} \\ \frac{\partial δ {g}_{{z}_{t}}}{\partial {x}_{g}} & \frac{\partial δ {g}_{{z}_{t}}}{\partial {y}_{g}} & \frac{\partial δ {g}_{{z}_{g}}}{\partial {z}_{g}}\end{matrix} ) \qquad [ Math . 7 ]$$

Where (δgₓ_{_{g}}, δg_{y}_{_{g}}, δg_{z}_{_{g}}) are the coordinates of the gravity disturbing vector in reference frame [g] at the position defined by latitude L, longitude G and ellipsoidal altitude z_{g} and where a component such as

$$\frac{\partial δ {g}_{{x}_{g}}}{\partial {y}_{g}}$$

represents the variation dδgₓ_{_{g}} of δgₓ_{_{g}} when the linear position (as opposed to the angular position) varies along the axis y of [g] by the value dy_{g}, the enriched gravity vector and its spatial gradient matrix being calculated by:

$${g}_{q} = {g}_{q}^{normal} + {γ}_{q} \qquad [ Math . 8 ]$$

$${J}_{{g}_{q}} = {J}_{{g}_{q}^{normal}} + {J}_{{γ}_{q}}$$

where

$${g}_{q}^{normal} , {γ}_{q} , {J}_{{g}_{q}^{normal}} , {J}_{{γ}_{q}}$$

are defined at the same altitude z_{g} and the same horizontal position, it being possible to calculate the enriched gravity vector equivalently in the algorithm for calculating the navigation state by integrating the velocity with the vector

$${g}_{q}^{normal}$$

and supplementing the accelerometric measurements with γ_{q}, one possible approximation, valid up to 100 km altitude for planet Earth, being in the reference frame (North, West, Top—such a reference frame is illustrated in [FIG. 7]):

$${g}_{g}^{normal} = ( \begin{matrix}{γ}_{a} ( f - \frac{5}{2} m ) sin 2 L \frac{{z}_{g}}{a} \\ - \frac{a {γ}_{a} {cos}^{2} L + b {γ}_{b} {sin}^{2} L}{\sqrt{{a}^{2} {cos}^{2} L + {b}^{2} {sin}^{2} L}} + {γ}_{a} [ ( 2 - f + \frac{9}{2} m + \\ ( 3 f - \frac{5}{2} m ) cos 2 L ) \frac{{z}_{g}}{a} - 3 {( \frac{{z}_{g}}{a} )}^{2} ]\end{matrix} ) \qquad [ Math . 9 ]$$

$${J}_{{g}_{q}^{normal}} = ( \begin{matrix}\frac{{γ}_{a}}{a} [ 2 - f + \frac{9}{2} m + & 0 & \frac{{γ}_{a}}{a} ( f - \frac{5}{2} m ) sin 2 L \\ ( 3 f - \frac{5}{2} m ) cos 2 L - 6 \frac{{z}_{g}}{a} ] & & \\ 0 & 0 & 0 \\ \frac{{γ}_{a}}{a} ( f - \frac{5}{2} m ) sin 2 L & 0 & \frac{{γ}_{a}}{a} [ 2 - f + \frac{9}{2} m + \\ & & ( 3 f - \frac{5}{2} m ) cos 2 L - 6 \frac{{z}_{g}}{a} ]\end{matrix} )$$

$$With :$$

$${γ}_{a} = \frac{GM}{ab} ( 1 - m - \frac{m}{6} \frac{{e}^{′} {q}_{0}^{′}}{{q}_{0}} ) \qquad [ Math . 10 ]$$

$${γ}_{b} = \frac{GM}{{a}^{2}} ( 1 + \frac{m}{3} \frac{{e}^{′} {q}_{0}^{′}}{{q}_{0}} )$$

$${q}_{0} = \frac{1}{2} [ ( 1 + \frac{3}{{e}^{{′}^{2}}} ) a tan ( {e}^{′} ) - \frac{3}{{e}^{′}} ]$$

$${q}_{0}^{′} = \frac{3}{{e}^{2}} ( 1 - \frac{1}{{e}^{′}} a tan {e}^{′} ) - 1$$

$$m = \frac{{ω}^{2} {a}^{2} b}{GM}$$

$${e}^{{′}^{2}} = \frac{{a}^{2} - {b}^{2}}{{b}^{2}}$$

$$b = a ( 1 - f )$$

Where (a, ƒ, ω, GM) are the geodesic parameters of the normal gravity model representing equatorial radius, flattening, angular velocity of rotation in inertial space, and product of the universal gravitational constant and the mass of the planet respectively.

In one alternative embodiment, the enriched gravity model provides a gravity vector and a spatial gradient matrix of this vector corresponding to the gravity anomaly vector Δg_{g} and a function of its Jacobian χ (J_{Δg}_{_{g}}) in the reference frame [g] at positions expressed in geographical coordinates (L, G, z_{g}) relative to the reference ellipsoid where L is the geographical latitude, G the longitude and z_{g} the ellipsoidal altitude, where χ( ) is a Jacobian approximating function, making it possible, for example, to force some terms to zero or to yield a local mean according to parameters, thus as an associated error model, the gravimetric vector and its spatial gradient matrix being γ_{q}=Δg_{g} and J_{γ}_{_{q}}=χ(J_{Δg}_{_{g}}) with:

$$Δ {g}_{g} = ( \begin{matrix}Δ {g}_{{x}_{g}} \\ Δ {g}_{{y}_{g}} \\ Δ {g}_{{z}_{g}}\end{matrix} ) \qquad [ Math . 11 ]$$

$${J}_{Δ {G}_{g}} = ( \begin{matrix}\frac{\partial Δ {g}_{{x}_{g}}}{\partial {x}_{g}} & \frac{\partial Δ {g}_{{x}_{g}}}{\partial {y}_{g}} & \frac{\partial Δ {g}_{{x}_{g}}}{\partial {z}_{g}} \\ \frac{\partial Δ {g}_{{y}_{t}}}{\partial {x}_{g}} & \frac{\partial Δ {g}_{{y}_{g}}}{\partial {y}_{g}} & \frac{\partial Δ {g}_{{y}_{g}}}{\partial {z}_{g}} \\ \frac{\partial Δ {g}_{{z}_{t}}}{\partial {x}_{g}} & \frac{\partial Δ {g}_{{z}_{t}}}{\partial {y}_{g}} & \frac{\partial Δ {g}_{{z}_{g}}}{\partial {z}_{g}}\end{matrix} )$$

Where (Δgₓ_{_{g}}, Δg_{y}_{_{g}}, Δg_{z}_{_{g}}) are the coordinates of the gravity anomaly vector in reference frame [g] at the position defined by latitude L, longitude G and ellipsoidal altitude z_{g}, and where a component such as

$$\frac{\partial Δ {g}_{{x}_{g}}}{\partial {y}_{g}}$$

represents the variation dΔgₓ_{_{g}} of Δgₓ_{_{g}} when the linear position (as opposed to the angular position) varies along the axis y of [g] by the value dy_{g}, the enriched gravity vector and its spatial gradient matrix being calculated by:

$${g}_{q} = {g}_{q}^{normal} + {γ}_{q} \qquad [ Math . 12 ]$$

$${J}_{{g}_{q}} = {J}_{{g}_{q}^{normal}} + {J}_{{γ}_{q}}$$

Where

$${g}_{q}^{normal} , {J}_{{g}_{q}^{normal}}$$

are defined at ellipsoidal altitude 0 at the horizontal position (L,G), and where γ_{q}, J_{γ}_{_{q}} are defined at the water surface at the same horizontal position (L,G). This case is reserved for maritime navigation. In this case,

$${g}_{q}^{normal} , {J}_{{g}_{q}^{normal}}$$

can be calculated in a simpler way than [Math. 9] and [Math. 10] with the following expressions:

$${g}_{g}^{normal} = ( \begin{matrix}0 \\ 0 \\ - \frac{a {γ}_{a} {cos}^{2} L + b {γ}_{b} {sin}^{2} L}{\sqrt{{a}^{2} {cos}^{2} L + {b}^{2} {sin}^{2} L}}\end{matrix} ) \qquad [ Math . 13 ]$$

$${J}_{{g}_{q}^{normal}} = ( \begin{matrix}\frac{{γ}_{a}}{a} [ 2 - f + \frac{9}{2} m + & 0 & \frac{{γ}_{a}}{a} ( f - \frac{5}{2} m ) sin 2 L \\ ( 3 f - \frac{5}{2} m ) cos 2 L ] & & \\ 0 & 0 & 0 \\ \frac{{γ}_{a}}{a} ( f - \frac{5}{2} m ) sin 2 L & 0 & \frac{{γ}_{a}}{a} [ 2 - f + \frac{9}{2} m + \\ & & ( 3 f - \frac{5}{2} m ) cos 2 L ]\end{matrix} )$$

calculating the enriched gravity vector can be performed equivalently in the algorithm for calculating the navigation state by integrating the velocity with the vector

$${g}_{q}^{normal}$$

and supplementing the accelerometric measurements with γ_{q}.

In one embodiment, the enriched gravity model provides a gravity vector and a spatial gradient matrix of this vector corresponding to the gravity vector G_{g} the same being attraction exerted by the mass of the planet, and a function of its Jacobian χ(J_{G}_{_{g}}) in the reference frame [g] at positions expressed in geographical coordinates (L, G, z_{g}) relative to the reference ellipsoid where L is the geographical latitude, G the longitude and z_{g} the ellipsoidal altitude, where χ( ) is a Jacobian approximating function, making it possible, for example, to force some terms to zero or to yield a local mean according to parameters, as well as an associated error model, the gravimetric vector and its spatial gradient matrix being γ_{q}=G₉ and J_{γ}_{_{q}}=χ(J_{G}_{_{g}}) with:

$${G}_{g} = ( \begin{matrix}{G}_{{x}_{g}} \\ {G}_{{y}_{g}} \\ {G}_{{z}_{g}}\end{matrix} ) \qquad [ Math . 14 ]$$

$${J}_{{G}_{g}} = ( \begin{matrix}\frac{\partial {G}_{{x}_{g}}}{\partial {x}_{g}} & \frac{\partial {G}_{{x}_{g}}}{\partial {y}_{g}} & \frac{\partial {G}_{{x}_{g}}}{\partial {z}_{g}} \\ \frac{\partial {G}_{{y}_{t}}}{\partial {x}_{g}} & \frac{\partial {G}_{{y}_{g}}}{\partial {y}_{g}} & \frac{\partial {G}_{{y}_{g}}}{\partial {z}_{g}} \\ \frac{\partial {G}_{{z}_{t}}}{\partial {x}_{g}} & \frac{\partial {G}_{{z}_{t}}}{\partial {y}_{g}} & \frac{\partial {G}_{{z}_{g}}}{\partial {z}_{g}}\end{matrix} ) \qquad [ Math . 15 ]$$

Where (Gₓ_{_{g}}, G_{y}_{_{g}}, G_{z}_{_{g}}) are the coordinates of the gravitational vector in the reference frame [g] at the position defined by latitude L, longitude G and ellipsoidal altitude z_{g}, and where a component such as

$$\frac{\partial {G}_{{x}_{g}}}{\partial {y}_{g}}$$

represents the variation dGₓ_{_{g}} of Gₓ_{_{g}} when the linear position (as opposed to the angular position) varies along the axis y of [g] by the value dy_{g}, the enriched gravity vector and its spatial gradient matrix being calculated by:

$${g}_{q} = {γ}_{q} + {γ}_{g}^{e} \qquad [ Math . 16 ]$$

$${J}_{{g}_{q}} = {J}_{{γ}_{q}} + {J}_{{γ}_{g}^{e}}$$

Where

$${γ}_{g}^{e}$$

is the centrifugal acceleration due to the planet rotation in space and where

$$\\ {γ}_{q} , {γ}_{g}^{e} , {J}_{{γ}_{q}} , {J}_{{γ}_{g}^{e}}$$

are calculated at the same inertial position (L, G, z_{g}), with:

$$\\ \begin{matrix}{γ}_{g}^{e} = {ω}^{2} \cdot ( {R}_{E} + {z}_{g} ) \cdot cos L ( \begin{matrix}- sin L \\ 0 \\ cos L\end{matrix} ) & [ Math . 17 ]\end{matrix}$$

$$\\ {J}_{{γ}_{g}^{e}} = {ω}^{2} ( \begin{matrix}1 - ( 1 + \frac{{R}_{E} + {z}_{g}}{{R}_{N} + {z}_{g}} ) {cos}^{2} L & 0 & - ( 1 + \frac{{R}_{E} + {z}_{g}}{{R}_{N} + {z}_{g}} ) sin L cos L \\ 0 & 0 & 0 \\ - sin L cos L & 0 & {cos}^{2} L\end{matrix} )$$

Of course, some terms may be approximated during the calculation.

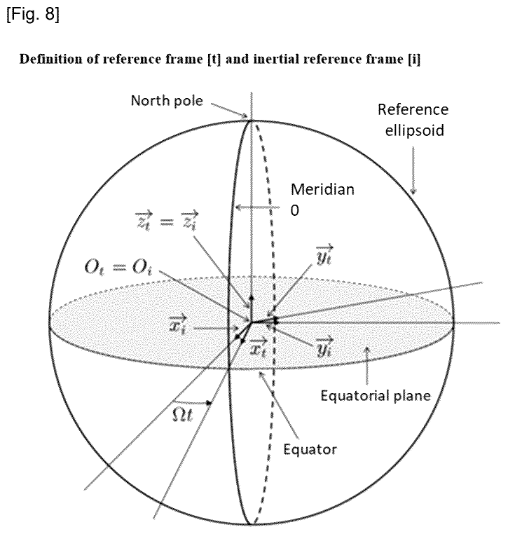

In one alternative embodiment, the enriched gravity model provides a gravity vector and a spatial gradient matrix of this vector corresponding to the gravity vector Gₜ and a function of its Jacobian χ(J_{G}_{ₜ}) in the geocentric reference frame [t] (such a frame is illustrated in [FIG. 8] planet-fixed at positions expressed in Cartesian coordinates (xₜ, yₜ, zₜ)), where χ( ) is a Jacobian approximating function, making it possible, for example, to force some terms to zero or to yield a local mean according to parameters, as well as an associated error model, the gravimetric vector and its spatial gradient matrix being γ_{q}=Gₜ and J_{γ}_{_{q}}=χ(J_{G}_{ₜ}) with:

$$\\ \begin{matrix}{G}_{t} = ( \begin{matrix}{G}_{{x}_{t}} \\ {G}_{{y}_{t}} \\ {G}_{{z}_{t}}\end{matrix} ) & [ Math . 18 ]\end{matrix}$$

$$\\ {J}_{{G}_{t}} = ( \begin{matrix}\frac{\partial {G}_{{x}_{t}}}{\partial {x}_{t}} & \frac{\partial {G}_{{x}_{t}}}{\partial {y}_{t}} & \frac{\partial {G}_{{x}_{t}}}{\partial {z}_{t}} \\ \frac{\partial {G}_{{y}_{t}}}{\partial {x}_{t}} & \frac{\partial {G}_{{y}_{t}}}{\partial {y}_{t}} & \frac{\partial {G}_{{y}_{t}}}{\partial {z}_{t}} \\ \frac{\partial {G}_{{z}_{t}}}{\partial {x}_{t}} & \frac{\partial {G}_{{z}_{t}}}{\partial {y}_{t}} & \frac{\partial {G}_{{z}_{t}}}{\partial {z}_{t}}\end{matrix} )$$

Where (Gₓ_{ₜ}, G_{y}_{ₜ}, G_{z}_{ₜ}) are the coordinates of the gravitational vector in reference frame [t] at the position defined by latitude L, longitude G and ellipsoidal altitude z_{g}, and where a component such as

$$\\ \frac{\partial {G}_{{x}_{t}}}{\partial {y}_{t}}$$

represents the variation dGₓ_{ₜ} of Gₓ_{ₜ} when the linear position (as opposed to the angular position) varies along the axis y of [t] by the value dyₜ, the enriched gravity vector and its spatial gradient matrix being calculated by:

$$\\ \begin{matrix}{g}_{q} = {γ}_{q} + {γ}_{t}^{e} & [ Math . 19 ]\end{matrix}$$

$$\\ {J}_{{g}_{q}} = {J}_{{γ}_{q}} + {J}_{{γ}_{t}^{e}}$$

Where

$$\\ {γ}_{q} , {γ}_{g}^{e} , {J}_{{γ}_{q}} , {J}_{{γ}_{g}^{e}}$$

are calculated at the same position (L, G, z_{g}) corresponding to Cartesian coordinates (xₜ, yₜ, zₜ) in [t] with:

$$\\ \begin{matrix}{γ}_{t}^{e} = {ω}^{2} ( \begin{matrix}{x}_{t} \\ {y}_{t} \\ 0\end{matrix} ) & [ Math . 20 ]\end{matrix}$$

$$\\ {J}_{{γ}_{t}^{e}} = {ω}^{2} ( \begin{matrix}1 & 0 & 0 \\ 0 & 1 & 0 \\ 0 & 0 & 0\end{matrix} )$$

Other enriched models can also be used within the scope of the invention.

### Propagation Step 1E1

The method 100 according to the invention comprises a propagation step 1E1 during which the navigation state at the end of the cycle X̅_{k,fin}, is calculated on the basis of the navigation state at the start of the cycle X̅_{k,0}, inertial measurements, the gravity vector obtained from the enriched gravity model (and Newton laws of dynamics: this propagation is performed according to equations known to the field and detailed in part below, the equations in question depending on the mechanisation reference frame selected). Likewise, during this step, the error state at the end of propagation δX_{k|k-1} is calculated on the basis of the error state at the start of the cycle δX_{k-1|k-1}, a transition matrix φₖ, and the covariance matrix at the end of propagation P_{k|k-1} is calculated on the basis of the start-of-cycle covariance matrix P_{k-1|k-1}, the transition matrix φₖ, a model noise covariance matrix Qₖ, so that:

$$\\ \begin{matrix}δ {X}_{k \vert k - 1} = {ϕ}_{k} δ {X}_{k - 1 \vert k - 1} & [ Math . 21 ]\end{matrix}$$

$$\\ {P}_{k \vert k - 1} = {ϕ}_{k} {P}_{k - 1 \vert k - 1} {ϕ}_{k}^{t} + {Q}_{k}$$

In addition, the transition matrix φₖ is determined using at least one component, preferably a plurality of components, of the spatial gradient matrix of the gravity vector given by the enriched gravity model. In other words, during this step 1E1, at cycle k, the error state δX_{k-1|k-1} and its covariance matrix P_{k-1|k-1} at the start of the cycle are propagated, leading to the error state δX_{k|k-1} and its covariance matrix P_{k|k-1} at the end of cycle k. In addition, during this step 1E1, an observation matrix Hₖ is determined from the propagated navigation state X̅_{k,fin} and an observation model.

This propagation step 1E1 is illustrated in [FIG. 2] where the error at the start of the cycle δX_{k-1|k-1} corresponding to the uncertainty ellipsoid E1 is propagated so as to obtain the error after propagation step 1E1, δX_{k|k-1} corresponding to the uncertainty ellipsoid E2. The position errors are here assumed to be independent in order to simplify illustration, and the projection bottom left of [FIG. 2] shows the absence of correlation between δx and δy (the ellipses with thick solid lines E2 and thin solid lines E1 are superimposed in projection in the plane (δx, δy)). It is clear from [FIG. 2] that uncertainties in the position errors after propagation are unchanged. However, propagation between δx_{k-1|k-1} and δv_{z}_{_{k|k-1}} or between δy_{k-1|k-1} and δv_{z}_{_{k|k-1}} is present by virtue of the correlation between these quantities created by the presence of a gravity vector gradient. In other words:

$$\\ \begin{matrix}\{ \begin{matrix}δ {x}_{k \vert k - 1} = δ {x}_{k - 1 \vert k - 1} \\ δ {y}_{k \vert k - 1} = δ {y}_{k - 1 \vert k - 1} \\ δ {v}_{{z}_{k \vert k - 1}} = δ {v}_{{z}_{k - 1 \vert k - 1}} + \frac{\partial {g}_{z}}{\partial x} δ {x}_{k - 1 \vert k - 1} + \frac{\partial {g}_{z}}{\partial y} δ {y}_{k - 1 \vert k - 1}\end{matrix} & [ Math . 23 ]\end{matrix}$$

Furthermore, in this example

$$\\ δ {g}_{z} = ( \begin{matrix}\frac{\partial {g}_{z}}{\partial x} \\ \frac{\partial {g}_{z}}{\partial y} \\ 0\end{matrix} )$$

is selected equal to the vector

$$\\ ( \begin{matrix}1 \\ 1 \\ 0\end{matrix} ) ,$$

i.e. along the axis \vec{u₁}.

The axes defined by \vec{u₁} and \vec{u₂} are therefore special. Indeed, the propagation on δv_{z} of a given position error at a given azimuth is zero along the axis defined by \vec{u₂} and maximum along the axis defined by \vec{u₁}.

The present invention differs from the state of the art in particular in the elements taken into account during this propagation step 1E1 and in particular in taking at least one component of the spatial gradient matrix of the gravity vector, preferably several components of the spatial gradient matrix of the gravity vector, or even all nine components of the spatial gradient matrix of the gravity vector into account. In other words, the propagation matrix F(t), and therefore the transition matrix φₖ comprises at least one term, preferably a plurality of terms each dependent on a component of the gradient matrix of the gravity vector. As illustrated in the introduction, the use of one or more components of the gravity vector gradient matrix makes it possible to improve the error propagation model.

As a reminder, spatial gradient components of the gravity vector can be represented in the form of a matrix (here, in the case of a local geographic reference frame—other reference frames can of course be used):

$$\\ \begin{matrix}G = ( \begin{matrix}{g}_{xx} & {g}_{xy} & {g}_{xz} \\ {g}_{yx} & {g}_{yy} & {g}_{yz} \\ {g}_{zx} & {g}_{zy} & {g}_{zz}\end{matrix} ) & [ Math . 24 ]\end{matrix}$$

With

$$\\ {g}_{ij} = \frac{\partial {g}_{i}}{\partial {x}_{j}}$$

with i={x, y, z} j={x, y, z}, gᵢ is the component of the gravity vector along the axis i considered, the coordinate x being relative to the component of the position on the south-north axis, the coordinate y being relative to the component of the position with respect to the east-west axis and z being relative to the component of the position with respect to the axis pointing to the zenith (known as the local geographical reference).

From this component or these components, the propagation matrix F(t) (and therefore the transition matrix φₖ) and the observation matrix Hₖ where k is the index of the Kalman cycle considered, can be determined. More particularly, at least one component of the spatial gradient of the gravity vector is inserted into the error propagation function which calculates the propagation matrix F and, from the same, the transition matrix φ. In other words, the filter propagation model takes at least one component of the spatial gradient of the gravity vector into account, preferably resulting from an enriched model.

As a reminder, the transition matrix φₖ can be determined to order 1 using the propagation matrix F(t) using the following relationship:

$$\\ \begin{matrix}{ϕ}_{k} = I + {\int }_{{t}_{k}}^{{t}_{k + 1}} F ( τ ) d τ & [ Math . 25 ]\end{matrix}$$

where I is the identity matrix and F(t) is the propagation matrix.

In one embodiment, the vertical component of the gravity vector is measured using a gravimeter. However, such a measurement means is of large overall size and difficult to integrate into a small-sized localisation device DI.

So, in one alternative embodiment already mentioned, the component or components of the gravity gradient are determined by the calculation means MC using an enriched gravimetric model, from the estimated position PE of the carrier. More particularly, in this embodiment, determining at least one component of the spatial gravity gradient comprises:
determining, by the calculation means MC, using measurements resulting from the inertial sensor block BSI and from a gravity vector calculated using the enriched gravimetric model, the carrier navigation state including the position (velocity and attitude) of the carrier, referred to as the estimated position PE; and
determining, by the calculation means MC, the spatial gradient of the gravity vector using the enriched gravimetric model and said estimated position PE of the carrier, for example using a function converting the enriched gravimetric model into a gravity vector and an approximation of its Jacobian matrix, for example according to the gate of the gravity vector, or according to the coefficients of spherical harmonics.

The enriched gravity model could, for example, be the EGM2008 model (cf. N. K. Pavlis, S. A. Holmes, S. C. Kenyon and J. K. Factor. “An Earth Gravitational Model to Degree 2160: EGM2008”. EGU General Assembly 2008, Vienna, Austria, Apr. 13-18, 2008). More generally, as already illustrated hereinbefore, the enriched gravity model used can take different forms.

The simplest form consists of geographical maps of the gravity vector (three components) and the horizontal gradients of the gravity vector

$$\\ ( the six \frac{\partial }{\partial x} and \frac{\partial }{\partial y} components of the matrix G introduced previously ) .$$

However, it is not necessary to map all nine components because there are only five independent components of the spatial gradient of gravity.

Alternatively, the gravity model can take a compressed form of a list of coefficients, for example coefficients of spherical harmonics of the gravitational potential. Other bases such as ellipsoidal harmonics or spherical wavelets can also be used. To make use of them, it is possible to calculate the functions of the basis at the estimated position according to mathematical methods of the state of the art, and to make the appropriate linear combination to obtain the gravity vector and the matrix of the spatial gradients of the gravity vector. Many global models of the gravitational potential decomposed into spherical harmonics exist. For example, the EIGEN-6C4 model or the XGM2019 model.

Explanations of the decomposition of the gravitational potential into spherical harmonics can be found in the book “Physical geodesy, second edition”—Bernhard Hofman-Wellenhof, Helmut Moritz, Springer Wien Network, 2006. This book does not deal with spatial gradients of the gravitation or gravity vector. However, this aspect is covered in the paper “On the computation of the gravitational potential and its first and second order derivatives”, R. Koop and D. Stelpstra—Manuscripta geodaetica—Volume 14—pages 373-382.

In one embodiment, the inertial localisation device DI comprises a calculation means MC, an inertial sensor block BSI and at least one external sensor CE, the method preferably comprising, prior to the propagation step, an alignment phase during which the calculation means MC initialises the navigation state and its uncertainty.

In one embodiment, each cycle k is divided into N time intervals ΔT₁ as well as P time intervals ΔT₂ so that T_{filter}=NΔT₁=rPΔT₁=PΔT₂ where N=rP and r and P are non-zero positive integers and where T_{filter} is the filter period.

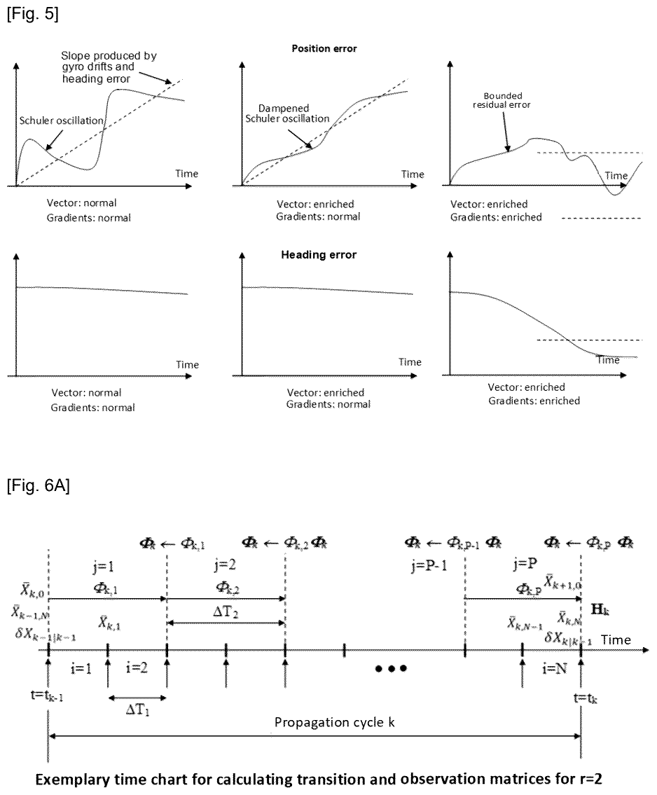

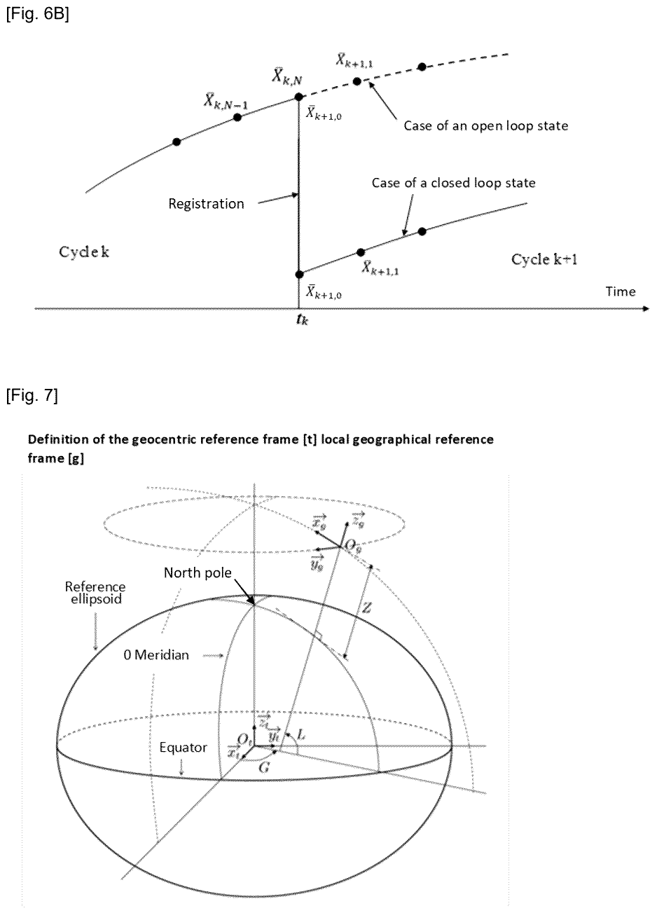

In this embodiment, as illustrated in [FIG. 6A], during propagation step 1E1, each cycle k comprises, for each interval ΔT₁ marked with the index i, between 1 and N, a sub-step 1E11 of calculating the navigation state X̅_{k,i} (including the position, velocity and attitude of the carrier) by propagating the state X̅_{k,i-1} from the measurements of the inertial sensor block BSI, the enriched gravimetric model at the position of the state X̅_{k,i-1} and Newton laws of dynamics.

In addition, during this step, an integration relative to time of the propagation matrix F(t) is implemented, this integral then being used to calculate an elementary transition matrix at regular intervals (noted interval j). Indeed, as discussed below, a calculation of an elementary transition matrix φ_{k,j} is performed at intervals j with

$$j = E ( \frac{i - 1}{r} ) + 1$$

where E(x) is the floor of x, initialised to the identity matrix when i=(j−1)r+1, j being an integer between 1 and P, and completed by the integration relative to time of the propagation matrix F(t) over the r time intervals ΔT₁ making up the interval ΔT₂ with the index j, where F is the propagation matrix corresponding to the linearised propagation function ƒ(t)f linearised (ƒ(t) which can be simplified or considered constant over the interval ΔT₁).

More particularly, the propagation matrix is integrated using a discretised version of the relationship [Math. 25] introduced previously, for example using a counter initialised at each interval i between 1 and N such that i−1 is a multiple of r positive or zero. In other words, for F(t) considered constant over ΔT₁, the value F(t)ΔT₁ is added to the identity matrix as the iterations proceed, so as to progressively make up the transition matrix φ_{k,j} on an interval ΔT₂.

For this, in one exemplary embodiment, reading the enriched gravimetric vector at iteration i is performed into the enriched gravimetric model in the form of a column matrix expressed in a reference frame [q]. The enriched gravity vector is then converted into an enriched gravity vector in reference frame [q], the enriched gravity vector being a functional of the enriched gravity vector. Finally, using a transition matrix T_{pq} the enriched gravity vector is expressed in the reference frame [p].

To this end, in one exemplary embodiment, the navigation mechanisation reference frame is a reference frame [p] and the gravimetric model is expressed in a reference frame [q]. As already mentioned, for this propagation the transition matrix is obtained from the propagation matrix calculated according to the state of the art, and comprising the 3×3 propagation sub-matrix

$${F}_{{( δ \vec{v} )}_{[ p ]} {( δ \vec{x} )}_{[ p ]}}$$

which propagates the position error vector (δ\vec{x})_{[p]} expressed in reference frame [p] to the velocity error vector (δ\vec{v})_{[p]} expressed in reference frame [p], with:

$${F}_{{( δ \vec{v} )}_{[ p ]} {( δ \vec{x} )}_{[ p ]}} = {T}_{pq} {J}_{{g}_{q}} {T}_{pq}^{t} + {M}_{q} \qquad [ Math . 26 ]$$

where T_{pq} is the transition matrix from the frame [q] in which the gravity vector is expressed to the mechanisation frame [p], where

$${T}_{pq}^{t}$$

is the transpose matrix of T_{pq}, where J_{g}_{_{q}} is the approximated spatial gradient matrix of the column matrix of coordinates in reference frame [q] of the enriched gravity vector

$${g}_{q} = ( \begin{matrix}{g}_{xq} \\ {g}_{yq} \\ {g}_{zq}\end{matrix} )$$

calculated on the basis of the enriched gravimetric model, comprising at least one spatial gradient of this gravity vector, and where M_{q} is a 3×3 matrix modelling effect of the curvature of the reference ellipsoid on the velocity error and depending on the coordinate system in which the gravimetric model is expressed.

The calculation of M_{q} depends on how the enriched gravity model is used. If the gravity model is utilised by locating position of points using their Cartesian coordinates (xₜ, yₜ, zₜ) in the planet-fixed geocentric reference frame [t](see figure at the end), then the reference frame [q] is equal to the reference frame [t] and M_{q}=0_{3×3}.

If the gravimetric model is utilised by locating position of points by their geographical coordinates (L, G, z_{g}) relative to the reference ellipsoid where L is the geographical latitude, G the longitude and Z_{g} the ellipsoidal altitude, then the reference system [q] is equal to the local geographic coordinate system [g] (North, West, Top), and:

$${M}_{q} = {T}_{pg} ( \begin{matrix}\frac{{g}_{zg}}{{R}_{N} + {z}_{g}} & \frac{{g}_{yg}}{{R}_{E} + {z}_{g}} tan L & 0 \\ 0 & \frac{{g}_{zg}}{{R}_{E} + {z}_{g}} - \frac{{g}_{xg}}{{R}_{E} + {z}_{g}} tan L & 0 \\ - \frac{{g}_{xg}}{{R}_{N} + {z}_{g}} & - \frac{{g}_{yg}}{{R}_{E} + {z}_{g}} & 0\end{matrix} ) {T}_{pg}^{t} \qquad [ Math . 27 ]$$

where R_{N} and R_{E} are the North and East radii of the reference ellipsoid relative to which the geographic coordinates are defined, and where Z_{g} is the ellipsoidal altitude, with:

$${R}_{N} = \frac{a ( 1 - {e}^{2} )}{{( 1 - {e}^{2} {sin}^{2} L )}^{3 / 2}} \qquad [ Math . 28 ]$$

$${R}_{E} = \frac{a}{{( 1 - {e}^{2} {sin}^{2} L )}^{1 / 2}}$$

Where a is the equatorial radius of the reference ellipsoid, and e is its eccentricity.

In one embodiment, g_{xg} and g_{yg} can be forced to zero in the matrix M_{q} which is then given by:

$${M}_{q} = {T}_{pg} ( \begin{matrix}\frac{{g}_{zg}}{{R}_{N} + {z}_{g}} & 0 & 0 \\ 0 & \frac{{g}_{zg}}{{R}_{E} + {z}_{g}} & 0 \\ 0 & 0 & 0\end{matrix} ) {T}_{pg}^{t} \qquad [ Math . 29 ]$$

In another embodiment, the local geographic reference frame can be defined by the axes (North, East, Bottom) where g_{xg} and g_{yg} may or may not be forced to zero, the new formula becoming:

$${M}_{q} = {T}_{pg} ( \begin{matrix}\frac{- {g}_{zg}}{{R}_{N} - {z}_{g}} & \frac{{g}_{yg}}{{R}_{E} - {z}_{g}} tan L & 0 \\ 0 & - \frac{{g}_{zg}}{{R}_{E} - {z}_{g}} - \frac{{g}_{xg}}{{R}_{E} - {z}_{g}} tan L & 0 \\ \frac{{g}_{xg}}{{R}_{N} - {z}_{g}} & \frac{{g}_{yg}}{{R}_{E} - {z}_{g}} & 0\end{matrix} ) {T}_{pg}^{t} \qquad [ Math . 30 ]$$

In one embodiment, during propagation step 1E1, for each index interval ΔT₁ with the index i non-zero multiple of r, at the resulting sub-step 1E11, a transition matrix φ_{k,j} being available with

$$j = \frac{i}{r}$$

between 1 and P, being an index of an interval ΔT₂, a sub-step 1E12 comprises calculating the transition matrix φₖ initialised at the identity matrix at the start of cycle k, progressively obtained at each new value of j by the matrix product φₖ←φ_{k,j}·φₖ. As a reminder, the transition matrix for cycle k is obtained by multiplying the elementary transition matrices φ_{k,j} of all the intervals ΔT₂ of cycle k. So, by taking the product of the elementary matrices at each new value of j, the transition matrix associated with the cycle k is given by the value of φₖ obtained at the last interval ΔT₂ of the cycle k considered. In one embodiment, during this sub-step 1E12, the navigation error x_{k,j} and its covariance matrix are also calculated from the navigation error state for the preceding interval x_{k,j-1} using the following relationship:

$${x}_{k , j} = {ϕ}_{k , j} {x}_{k , j - 1}$$

Where φ_{k,j,j-1} is an elementary propagation matrix, x_{k,0} being given by δX_{k-1|k-1} and δX_{k|k-1} being given by x_{k,P}.

These time intervals make it possible to maintain the correlation that exists between the position error and the velocity error during the cycle k considered, until the moment of the during update step 1E2 (described later).

Propagation step 1E1 also comprises, at the end of the last interval (i=N and j=P), a sub-step 1E13 of calculating the observation matrix Hₖ on the basis of the propagated navigation state X̅_{k,N} and an observation model, and calculating the propagation of the error state and the covariance matrix of this state:

$$δ {X}_{k \vert k - 1} = {ϕ}_{k} δ {X}_{k - 1 \vert k - 1}$$

$${P}_{k \vert k - 1} = {ϕ}_{k} {P}_{k - 1 \vert k - 1} {ϕ}_{k}^{t} + {Q}_{k}$$

In one embodiment, the inertial localisation device DI comprises a gravimeter measuring the gravity modulus and (in addition to calculating the transition matrix based on the approximated spatial gradient matrix of the enriched gravity vector) calculating the observation matrix Hₖ at the end of propagation step 1E1 is performed using the horizontal gradients of the vertical component of gravity in the reference frame [g] which are extracted from the enriched gravity model.

In one embodiment, the transition matrix also comprises terms relating to the gravity vector (in addition to the gradient), and the value of this gravity vector is determined using the enriched gravity model. In one embodiment, in order to improve robustness of the estimation, an error model of the gravity model can be used in the propagation step E1.

### Update Step 1E2

The method 100 according to the invention then comprises an update step 1E2.

Update step 1E2 first comprises a sub-step 1E21 of measuring, using the external sensor, an observable relating to at least one function of the velocity and/or position of the carrier. It is understood that a velocity or position observable is considered to be an observable relating to at least one function of the velocity or position—generally speaking, an observable is considered to be a function of the velocity or position when the value taken by this observable is a function of the value of the velocity or position.

For this, in one embodiment, the inertial localisation device comprises an altitude sensor, i.e. a sensor for determining position of the carrier along the axis z (in the local reference frame). This embodiment is particularly advantageous insofar as an inertial unit generally comprises such a sensor.

In one alternative or complementary embodiment, the inertial localisation device comprises a gravimeter, a velocity sensor (e.g. based on the Doppler effect), a camera, a laser rangefinder, a lidar, a radar and/or any other registration means. In one embodiment, the error model of the stochastic filter includes states supplementing the gravity vector calculated on the basis of the enriched gravimetric model, these states participating in the propagation of velocity errors and being registered by observations, thus constituting a gravimetric measurement integrated into the inertial localisation unit.

In one embodiment, the carrier is a boat and the external sensor is a virtual sensor. Indeed, insofar as the altitude is given by the water level, it is not necessary to take a measurement. In particular, for a carrier at sea, the altitude measurement can be considered to be equal to zero or even read from an ellipsoidal altitude map of the geoid.

It will be noted that the device according to the invention can comprise a plurality of external sensors, an observable per external sensor then being measured during measurement sub-step 1E21.

Lastly, the update step 1E2 comprises a sub-step 1E22 of updating, by the calculation means (MC), the stochastic filter state on the basis of the measurement performed during the preceding measurement sub-step 1E21 so as to at least partly reduce the error state δX. This step is implemented in the same way as the methods of the state of the art. As a reminder, in the extended Kalman filter, for example, an innovation is calculated corresponding to the discrepancy between the measurement taken and the predicted measurement using the observation matrix and the propagated state. A gain matrix is then calculated and the state is corrected by multiplying the gain by the innovation. The covariance matrix of the state is corrected according to this gain and according to the observation matrix Hₖ. There is an optimal gain minimising trace of the covariance matrix P_{k|k}, depending on the propagated covariance matrix P_{k|k-1} and the observation matrix Hₖ.

For each cycle kat the end of the update step, a correction at time tₖ referred to as registration, illustrated in [FIG. 6B], determines, according to techniques of the state of the art, the initial value X̅_{k+1,0} of the navigation state for the next cycle on the basis of the state X̅_{k,N} at that time combined with the part δX_{k|k}_{ₙₐᵥ} of the error state δX_{k|k} containing the navigation error estimations, and determines the initial value at cycle k+1 of complementary states contributing to the quality of the navigation state estimations on the basis of their value at the end of cycle k combined with the part of the error state δX_{k|k} containing the errors estimated on these complementary states, then δX_{k|k} is reset, the state registrations and error state resets being applied to all or some of these states at time tₖ, the registered state components being referred to as “closed-loop states” and the others as “open-loop states”; the navigation states X̅_{k+1,0} combined with the navigation part δX_{k|k}_{ₙₐᵥ} of the error state δX_{k|k} (whose closed-loop components are zero) form the navigation solution at the end of cycle k at time tₖ associated with confidence intervals extracted from the covariance sub-matrix P_{k|k}_{ₙₐᵥ} resulting from P_{k|k} containing the covariance of the navigation error states.

Update step 1E2 is illustrated in [FIG. 2], where the error after updating δX_{k|k} corresponds to the uncertainty ellipsoid E3. In this example, observation is only made according to the z component of velocity. When this observation occurs, it is taken into account in the Kalman filter update step and, if the optimal Kalman gain is used, the uncertainty ellipsoid is reduced along the axis δv_{z} while remaining inscribed in the ellipsoid E2 and being tangent to the same at the intersection of the ellipsoid E2 and the unobserved state space points so as to obtain the ellipsoid E3.

Furthermore, the points of the ellipsoid E2 belonging to the plane (δx, δy) passing through the origin are statistically unchanged by the observation because they correspond to state vectors belonging to the plane orthogonal to the axis of observation. These points therefore also belong to the ellipsoid E3. These points form of an ellipse in the plane (δx, δy), which is not represented except in the top left figure, where they are represented by two small circles.

The fact that the ellipsoid E3 is inscribed in the ellipsoid E2 results in the occurrence of a correlation between position errors in the plane (δx, δy). The position uncertainty ellipse has therefore reduced in the direction \vec{u}₁ corresponding to the direction of the horizontal gradient of gravity.

### Examples of External Sensors

As already mentioned, the method according to the invention resorts to one or more external sensors to measure one observable, or even several observables. By way of introduction to the description, the examples have been illustrated using a measurement of altitude or velocity along the axis z. However, as already discussed, other external sensors can be used within the scope of the method 100 according to the invention.

In one embodiment, the external sensor is a laser rangefinder. Observation then consists of measuring the carrier distance relative to a point (known or unknown). In particular, the position error produces an observable acceleration error corresponding to that of the gravity vector projected onto the visual axis. \vec{g}ᵥᵢₛᵤₐₗ. In the method according to the invention, when the zone of uncertainty in position is included in the linearity zone of the gravity vector, the spatial gradient matrix of the gravity vector calculated on the basis of the enriched gravimetric model enables this acceleration error to be modelled linearly on the basis of the position error vector in three dimensions. This acceleration error creates a velocity error on this projection axis, as well as a discrepancy between the predicted distance and the distance actually measured. The gains of the filter are applied to this discrepancy (or innovation) to correct the state vector (for the record, the state vector includes the position, velocity and attitude errors, as well as the error model of the inertial and external sensors) when the filter is updated. Thus, in the method according to the invention, the position error along the visual axis is corrected directly by the rangefinder measurement, while the error on the other two components, those located in a plane orthogonal to the visual axis, are corrected on the basis of the spatial gradient matrix of the gravity vector calculated on the basis of the enriched gravimetric model in said plane, the gradients providing the most information being those describing variations in the projection of the gravity vector on the visual axis on the basis of the position errors in said plane, thus establishing correlations between the velocity error on the visual axis and the position errors in this plane. When the visual axis is vertical, the observation is an altitude observation and these gradients correspond to the horizontal gradients of the z component of gravity. This is the case discussed in the introduction. More generally, when the visual axis is constant, as in the case of the vertical axis, two gradients of the gravity vector may suffice. On the other hand, when the visual axis is variable, it is necessary to have the nine spatial gradients of the gravity vector calculated from the enriched gravimetric model so as to be able to observe the position errors in the plane orthogonal to the visual axis, whatever its orientation. The position error can of course be observed according to a linear combination of spatial gradients depending on the visual axis. It will be noted that the same principle can be adopted with Lidar.

Likewise, some inertial localisation units also have a camera. The displacement of fixed points relative to the Earth in the image provides information on the carrier displacement in parallel to the image plane. In particular, the position error produces an observable acceleration error corresponding to that of the gravity vector projected onto the plane \vec{g}_{image}. In the method according to the invention, when the zone of uncertainty in position is included in the linearity zone of the gravity vector, the spatial gradient matrix of the gravity vector calculated on the basis of the enriched gravimetric model enables this acceleration to be modelled linearly on the basis of the position error vector in three dimensions. This acceleration creates a velocity error in projection in the image plane. This creates a discrepancy between the predicted position of the fixed points in the image and the position actually observed. Filter gains are applied to this discrepancy to correct the state vector when the filter is updated. The position component in the plane is directly corrected by this type of observation. The other position component, that located on the visual axis, is corrected according to the spatial gradient of the gravity vector calculated from the enriched gravimetric model, the gradients providing the most information being those describing the variations in the projection \vec{g}_{image} of the gravity vector in the image plane as a function of the position error on the visual axis, thus establishing correlations between the velocity errors in the image plane and the position error on the visual axis. Measuring errors in the image plane therefore makes it possible to correct errors on the visual axis, with the information acquired depending on the amplitude of the spatial gradients. When the visual axis is constant, as in the case of the vertical axis, two gradients in the gravity vector may suffice. On the other hand, when the visual axis is variable, it is necessary to have all nine spatial gradients.

Alternatively, when the visual axis is slaved to a fixed point, this velocity error is present in the visual axis control. This information can be processed as a measurement in order to correct the position error on the visual axis through the spatial gradient matrix along the visual axis of the projection \vec{g}_{image} in the image plane of the gravity vector calculated from the enriched gravity model. This method can be more precise than the first, which depends on the number of pixels in the image. If the camera is aiming at nearby points, the succession of images also provides information about the visual axis without the aid of the spatial gradients of the gravity vector. The correlation between the velocity error and the position error then provides additional information and further improves estimation. If the camera is aimed at distant points such as stars (stellar vision), very little information along the visual axis is acquired by the succession of images because the stars are too far away, and only the gravimetric correlation between the velocity error and the position error can be used to acquire this information. Of course, several cameras can be used on the same principle.

In all cases, a gravimeter can be added to the external sensors in order to improve the performance of the vertical chain and to estimate, for example, the accelerometric bias of the vertical inertial chain. This bias is indeed a limit to the performance of the gravimetric correlation between velocity error and position error when only the altitude sensor is available. By making use of an external gravimeter, it is thus possible to lower the limit and improve performance.

Advantages Associated with the Method According to the Invention

The method according to the invention enables fast carriers to benefit from the multiple advantages of the correlation between velocity error and position error without necessarily using a gravimeter. Not only can position errors be corrected, but also gyroscopic drift errors, velocity errors, attitude errors and heading errors.

[FIG. 5] illustrates this by comparing the trends in the behaviour of the position and heading error of an altitude hybridised inertial localisation unit, this behaviour also depending on the quality of the inertial sensor block, the mechanical damping elements and the thermal environment, as well as the quality of the altitude sensor, using three types of gravimetric model on a time scale of a few hours:
The default mode corresponding to the normal model applied to gravity vectors and spatial gravity gradients, which corresponds to a first method according to the state of the art (the two leftmost graphs in [FIG. 5]);
The mode sometimes referred to as “compensation” corresponds to an enriched gravimetric model to describe vertical discrepancies or the complete gravity vector, but where the spatial gradients are described by the normal model, which corresponds to a second method according to the state of the art (the two graphs in the centre of [FIG. 5]);
The gravimetric correlation mode which corresponds to the implementation of a method according to the invention (the two rightmost graphs in [FIG. 5]).

### Horizontal Position Error of an Altitude Hybridised Unit

In the default mode, the horizontal position error includes Schuler oscillations, as well as errors related to gyroscopic errors and heading error. As a reminder, part of the Schuler oscillations are due to the profile of vertical discrepancies along the trajectory, the other part being related to accelerometric and gyrometric errors, as well as alignment errors.

Observation of the position or velocity sensor or the gravimeter makes it possible to observe part of the horizontal position through the correlation between the velocity error and the position error. The course of said horizontal position along the trajectory contains information on the gyroscopic drift and on the heading and its partial observation nevertheless makes it possible to reduce the errors on these quantities in geographical zones including relief, which may make it possible to advantageously replace the GNSS signal when the same is unavailable. In the method according to the invention, the originality consists in reducing the errors on this quantity based on an altitude measurement (and not on a measurement resulting from GNSS) by using horizontal gradients of the gravity vector calculated based on an enriched gravimetric model in the propagation matrix F. To be more precise, other components of the gradient also contribute, to a lesser extent, to reducing the errors: horizontal position errors propagate not only along the vertical axis, but also along the horizontal velocity errors through the other gradients and then propagate along the vertical axis. Thus, they help to observe gyro and heading errors. By measuring an observable other than altitude (for example with a laser rangefinder used repeatedly over time), the other gradients can make a greater contribution to the observation of gyroscopic and heading errors.

In the compensated mode, some of the Schuler oscillations are attenuated because the high-resolution gravity model reduces excitation of these oscillations due to the profile of the vertical discrepancies along the trajectory. However, this does not reduce the slope of the position error.

In the gravimetric correlation mode between velocity error and position error, the Kalman filter algorithm is used to estimate the position error from knowledge of the spatial gradients of the gravity vector and from the measurement of the registration means, whatever the source of the position errors.

### Heading Error of an Altitude Hybridised Unit

In the default mode, the heading error is poorly estimated. The explanation for its poor observability can be found in the literature. As shown in [FIG. 5], the compensation mode does not improve heading estimation.

On the other hand, in the gravimetric correlation mode between velocity error and position error, when the carrier performs a manoeuvre, the horizontal specific force measured by the accelerometers is projected into the platform reference frame with a heading error producing a horizontal velocity error and therefore a horizontal position error, and as part of the position error (the projection of the error in the direction of the spatial gradient of gravity) is observed, it is possible to improve the heading estimation in a few hours. For a submarine or surface boat not making use of GNSS, measurements can be taken regularly over several days. The heading error is one of the contributors to a horizontal position oscillation with a 24-hour period. Observing it on this long time scale makes it easier to decorrelate it from other errors.

### Other Errors

In the gravimetric correlation mode between velocity error and position error, gyroscopic drift errors can be partially estimated. Indeed, gyroscopic drift has a major impact on the horizontal position error. Their signature depends on the trajectory of the carrier but includes, at least on the scale of a few hours, a position error slope, as well as Schuler oscillations. In the longer term, they also produce a longitude error slope and oscillations with a period of around 24 hours. In addition, the observation of Schuler oscillations of position also gives observability to the accelerometric errors.

### Solving Observability Problems

The method according to the invention increases size of the observable space to a greater or lesser extent depending on the amplitude of the spatial gradients of the gravity vector at the estimated position. The method according to the invention also makes it possible to solve conventional false observability problems.

In these problems, where the normal gravity model is used and the ellipsoidal altitude is low, the gravity vector is considered to have a quasi-constant modulus and is oriented along the geometric vertical at any point on the Earth. A change of orientation or translation does not change projections of the gravity vector in the local geographic reference frame. In stationary observation situations where the unobservable axes depend on the current state, a Kalman-type navigation filter can be caused to create false observability and become inconsistent: its estimated covariances decrease unjustifiably and no longer cover possible errors.

In the state of the art, these problems are solved in some cases by the invariant filter or the OCEKF filter (Observability-Constrained Extended Kalman Filter—in this type of filter, a model of the unobservable axes is used and the filter is forced not to make any observations along these axes). However, the OCEKF filter has a narrower field of use than an Extended Kalman Filter. The method according to the invention also makes it possible to solve some of these problems while retaining the Kalman filter, which has the advantage of operating in a wider field of use than the invariant filter or the OCEKF.

An example of an observability problem can be seen in the context of Simultaneous Localisation and Mapping (SLAM), related to the conventional problem of tracking characteristic points in the image in order to determine an estimation of velocity and position from the image in question.

Appropriate processing can be used to select these points and indicate that their velocity is zero. From the displacement of these points in the image, it is possible to deduce movement of the camera and therefore that of the carrier. This can be done using an inertial localisation unit coupled to the camera (in other words, the observable is measured using a camera). It is known that when movement is small, problems of false observability can occur if the stochastic filter is an extended Kalman filter. This is because observation is relative: the same scene can be created by rotating both the camera and the characteristic points without changing the observations. This is true if the gravity vector is orthogonal to the reference ellipsoid and of almost constant modulus at any point.

With a method according to the invention, the spatial gradient matrix of the gravity vector makes it possible to distinguish different possible orientations of the scene, and the axis which is not observable or only slightly observable with the gradients of the normal model can become observable with the gradients of the gravity vector calculated according to the enriched gravimetric model as used in the present invention.

Another problem of inconsistency in the Kalman filter in the state of the art exists when the carrier is moving: the apparent movement of the image points along the visual axis is zero. In scenarios where the trajectory is uniformly rectilinear, inconsistencies can then be created by the lack of observability along the visual axis.

A solution is provided by the method according to the invention by modelling the spatial gradients of the gravity vector of an enriched gravimeter, the same providing observability along the visual axis and thus reducing the risk of inconsistency in the extended Kalman filter.

### Inertial Localisation Device

A second aspect of the invention relates to an inertial localisation device (or inertial localisation unit) comprising means configured to implement a method according to the invention. More particularly, the device according to the invention comprises an inertial sensor block (comprising accelerometers and gyroscopes or gyrometers), a calculation means (for example an ASIC card or even a processor associated with a memory) and, preferably, mechanical damping elements to which the inertial sensor block is usually mounted in order to minimise impact of shocks and vibrations on the localisation accuracy. In one embodiment, the device according to the invention is configured to operate in:
a first mode, referred to as the alignment mode, which corresponds to the initialisation of the navigation state using measurements from the inertial sensor block and/or an external sensor;
a second mode, referred to as the navigation mode, in which mode the method according to the invention is implemented by the device according to the invention.

The device according to the invention also comprises at least one external sensor CE, for example an altimeter, a laser rangefinder or a camera. In one embodiment, the calculation means MC is associated with a memory, the memory comprising instructions and data required to implement the reduction method according to one aspect of the invention. The memory may especially comprise one or more gravity models and one or more gravity error models. In one embodiment, the inertial localisation device DI according to the invention is used in an inertial navigation device.

1. A method for inertially localising a carrier using a recursive Bayesian type stochastic filter implemented by an inertial localisation device, the method comprising a plurality of cycles, each cycle comprising a propagation step and an update step, wherein, during the propagation step, propagation is performed using a propagation model taking at least one component of a spatial gradient matrix of the gravity vector provided by an enriched gravimetric model into account.

2. The inertial localisation method according to claim 1, wherein the recursive Bayesian filter linearises a propagation law.

3. The inertial localisation method according to claim 1, wherein the inertial localisation device comprises a calculation means, an inertial sensor block and at least one external sensor, and for each cycle k with k a positive non-zero integer:
during the propagation step, the navigation state at the end of the cycle \tilde{X}_{k,fin} is calculated based on the navigation state at the start of the cycle \tilde{X}_{k,0}, of inertial measurements and of the gravity vector obtained from the enriched gravimetric model, the error state δX_{k|k-1} is calculated based on the error state δX_{k-1|k-1}, and the covariance matrix P_{k|k-1} of the error state δX_{k|k-1} is calculated based on the covariance matrix P_{k-1|k-1}, calculating the error state and its covariance being performed using a transition matrix φₖ at cycle k and a model noise covariance matrix Qₖ at cycle k so that:
$$δ {X}_{k \vert k - 1} = {ϕ}_{k} δ {X}_{k - 1 \vert k - 1}$$
$${P}_{k \vert k - 1} = {ϕ}_{k} {P}_{k - 1 \vert k - 1} {ϕ}_{k}^{t} + {Q}_{k}$$
the transition matrix φₖ being determined using at least one component of the spatial gradient matrix of the gravity vector obtained based on the enriched gravity model, an observation matrix Hₖ being then determined from the navigation state at the end of the cycle X̅_{k,fin} and an observation model;
during the update step, the error state after updating δX_{k|k} and the covariance matrix of the estimation error after updating P_{k|k} are calculated, by the calculation means and using the stochastic filter, from the error state before updating δX_{k|k-1}, the covariance matrix of the estimation error before updating P_{k|k-1}, a covariance matrix of the measurement noise Rₖ, the observation matrix Hₖ and a measurement of an observable relating to at least one function of the velocity and/or the position of the carrier performed by the external sensor during or at the end of the propagation step so as to at least partly reduce the error state after updating.

4. The inertial localisation method according to claim 3, wherein each cycle k is divided into N time intervals ΔT₁, as well as into P time intervals ΔT₂ so that T_{filter}=NΔT₁=rPΔT₁=PΔT₂ where N=rP and r and P are non-zero positive integers and where T_{filter} is the filter period, the propagation step of each cycle k comprising, from a propagation matrix F(t):
for each interval ΔT₁ marked with the index i, a sub-step of calculating the navigation state X̅_{k,i} by propagating the state X̅_{k,i-1} from the measurements of the inertial sensor block, the enriched gravimetric model at the position of the state X̅_{k,i-1};
for each interval ΔT₁ marked with the index i between (j−1)r+1 and (j−1)r+r, j being an integer between 1 and P designating the index of an interval ΔT₂ with
$$j = E ( \frac{i - 1}{r} ) + 1$$
where E(x) is the floor of x, a sub-step of calculating an elementary transition matrix φ_{k,j} initialised at the identity matrix at the start of the time interval ΔT₁ marked with the index i=(j−1)r+1 and completed by integrating the propagation matrix F(t) relative to time over the r time intervals ΔT₁ making up the interval ΔT₂, the matrix obtained by integrating the propagation matrix over a time interval ΔT₁ being added to the matrix obtained by integrating over the previous time interval ΔT₁ so as to progressively make up this elementary transition matrix φ_{k,j} and a transition matrix φₖ on cycle k initialised at the identity matrix being progressively calculated at each new value of j by the matrix product φₖ←φ_{k,j}, φₖ;
at the end of the last interval i, a sub-step of determining the observation matrix Hₖ from the propagated navigation state X̅ₖ and an observation model, and propagating the error state δX_{k|k-1} and the covariance matrix P_{k|k-1} using the transition matrix φₖ associated with cycle k considered and given by the elementary matrix calculated at interval i=N and the model noise matrix Qₖ using the relationships:
$$δ {X}_{k \vert k - 1} = {ϕ}_{k} δ {X}_{k - 1 \vert k - 1}$$
$${P}_{k \vert k - 1} = {ϕ}_{k} {P}_{k - 1 \vert k - 1} {ϕ}_{k}^{t} + {Q}_{k}$$

5. The inertial localisation method according to claim 1, wherein the inertial localisation device comprises a laser rangefinder and/or a lidar, and a measurement of the position and/or velocity of the carrier is performed by telemetry during the update step.

6. The inertial localisation method according to claim 1, wherein the localisation device comprises a camera and a measurement of the position and/or velocity of the carrier is performed by the camera during the update step.

7. The inertial localisation method according to claim 1, wherein the localisation device comprises a means for measuring vertical position and a measurement of the position and/or the vertical velocity of the carrier is performed by said measurement means during the update step.

8. An inertial localisation device comprising an inertial sensor block, at least one external sensor and means configured to implement a method according to claim 1.

9. A computer program comprising instructions which cause the device according to claim 8, when the instructions are executed by the device to implement a method for inertially localising a carrier using a recursive Bayesian type stochastic filter implemented by an inertial localisation device.

10. A computer-readable medium, having the computer program according to claim 9 recorded thereon.
